(19) United States
(12) Patent Application Publication
(10) Pub. No.: US 2012/0262906 A1
(43) Pub. Date: Oct. 18, 2012

(54) LED LIGHT

(75) Inventors: Frank Wimbert, Owen (DE); Philip Hupfer, Esslingen (DE)

(73) Assignee: FLEXTRONICS INTERNATIONAL KFT., Tab (HU)

(21) Appl. No.: 13/445,788

(22) Filed: Apr. 12, 2012

(30) Foreign Application Priority Data
Apr. 12, 2011 (DE) 20 2011 000852.5

(51) Int. Cl. F21V 5/04; F21V 33/00

(52) U.S. Cl. 362/92; 362/235

(57) ABSTRACT

An LED light (1), in particular a refrigerator light or the like, having at least one LED (2), having a lens (4) for the light that is emitted by the at least one LED (2), and having an opaque light housing (5) which encloses the lens (4), characterized in that the lens (4) has a transmissive design, and the opaque light housing (5) and the transmissive lens (4) are jointly formed by a two-component plastic injection-molded part (6).

### CROSS-REFERENCE TO RELATED APPLICATIONS

This application claims priority to German Patent Application No. 20 2011 000852.5, filed Apr. 12, 2011 and entitled “LED-Leuchte,” which is hereby incorporated by reference in its entirety as if set forth herein.

### FIELD OF THE INVENTION

The present invention relates to an LED light, in particular a refrigerator light or the like, having at least one LED, having a lens for the light that is emitted by the at least one LED, and having an opaque light housing which encloses the lens.

### BACKGROUND OF THE INVENTION

FIG. 1 shows a known LED refrigerator light 101, having an LED 102 that is situated on a printed circuit board 103. The LED 102 is surrounded by a reflector 104 which directs the light emitted by the LED 102 forward through a housing opening 105 in an opaque light housing 106 which covers the printed circuit board 103. The light housing 106 has a locking receptacle 107 in which the printed circuit board 103 is accommodated and locked by means of multiple locking catches 108 on the housing side. An aluminum body 109 for cooling the LED 102 is situated on the side of the printed circuit board opposite from the LED 102. The reflector 104 is situated between the printed circuit board 103 and the light housing 106, and is screwed to the aluminum body 109 by means of a screw 110, thus clamping the reflector 104 and the cooling body 109 to the printed circuit board 103 located in-between. The printed circuit board 103 has a plug 111 for connecting the LED 102 to a power supply.

For installation of the LED refrigerator light 101, the printed circuit board 103, the reflector 104, which has previously been provided with its reflective layer by vapor deposition, and the cooling body 109 are screwed to one another by means of the screw 110.

### SUMMARY OF THE INVENTION

In contrast, the object of the present invention is to reduce the number of individual parts and simplify installation for an LED light of the above-mentioned type.

This object is achieved according to the invention in that the lens has a transmissive design, and the opaque housing and the transmissive lens are jointly formed by a two-component plastic injection-molded part. The transmissive lens is preferably designed as a collimator lens or as an optical lens, in particular a Fresnel lens.

As a result of the two-component plastic injection-molded part according to the invention, which has a molded-on transmissive lens, it is possible to dispense with the vapor-deposited reflector and the screw heretofore used, and the installation of the reflector, printed circuit board, cooling body, and screw heretofore performed. Due to the higher efficiency of currently available LEDs, a cooling body is also no longer necessary.

For additional beam shaping, the exterior of the transmissive lens is smooth or is provided with structures, for example eroded structures, cushion lenses, cylindrical lens segments, etc.

The two-component plastic injection-molded part is preferably locked to a printed circuit board having at least one LED, for example via locking catches on the housing side, or is hot-caulked, for example using guide domes on the housing side. In addition, the two-component plastic injection-molded part, and thus the collimator lens, can be exactly positioned with respect to the at least one LED via projections which engage precisely with holes in the printed circuit board.

In one aspect of the invention, An LED light comprises: at least one LED; a lens for the light that is emitted by the at least one LED; and an opaque light housing which encloses the lens, characterized in that the lens has a transmissive design, and the opaque light housing and the transmissive lens are jointly formed by a two-component plastic injection-molded part. In some embodiments, the transmissive lens is designed as a collimator lens or an optical lens. In some embodiments, the transmissive lens is designed as a Fresnel lens. In some embodiments, the exterior of the transmissive lens is smooth. In some embodiments, the exterior of the transmissive lens is provided with structures for additional beam shaping. In some embodiments, the two-component plastic injection-molded part is locked to a printed circuit board having the at least one LED. In some embodiments, the two-component plastic injection-molded part is hot-caulked to a printed circuit board having the at least one LED. In some embodiments, the two-component plastic injection-molded part is exactly positioned with respect to the at least one LED via projections which engage precisely with holes in a printed circuit board having the at least one LED. In some embodiments, the projections are hot-caulked for fastening to the printed circuit board.

Advantageous embodiments of the invention are the subject matter of the subclaims. Further advantages of the invention result from the description and the drawings. In addition, the features mentioned above and explained in greater detail below can each be used individually, or collectively in any given combinations. The illustrated and described embodiment is not to be construed as an exhaustive list, but, rather, as an example for the description of the invention.

### BRIEF DESCRIPTION OF THE DRAWINGS

FIG. 1 shows an LED light according to the prior art; and

FIG. 2 shows an LED light according to the invention.

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the generic principles herein can be applied to other embodiments. Thus, the present invention is not intended to be limited to the embodiment shown, but is to be accorded the widest scope consistent with the principles and features described herein.

The LED refrigerator light 1 shown in FIG. 2 includes an LED 2 (or also multiple LEDs) which is/are situated on a printed circuit board 3. A transmissive lens in the form of a collimator lens 4 or an optical lens (Fresnel lens, for example) is situated in front of the LED 2, and directs the light emitted by the LED 2 forward. The collimator lens 4 together with an opaque light housing 5 which covers the printed circuit board 3 is formed by a two-component plastic injection-molded part 6. The collimator lens 4 is made of transparent plastic, and the light housing 5 is made of opaque plastic.

The exterior of the collimator lens 4 can be smooth, or, as shown in FIG. 2, can have structures 7, for example eroded structures, cushion lenses, or cylindrical lens segments, for additional beam shaping.

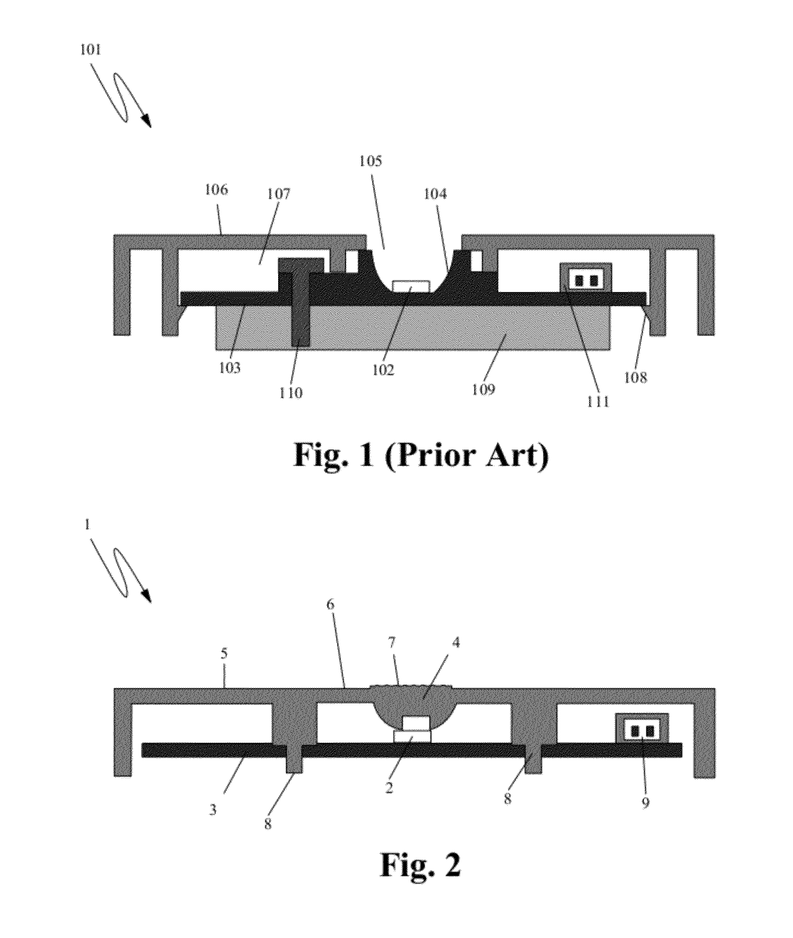

The plastic injection-molded part 6 engages precisely with holes in the printed circuit board 3 via projections (guide domes) 8 provided on the light housing 5, thus exactly positioning the collimator lens 4 and the LED 2 with respect to one another. The printed circuit board 3 rests on shoulders of the projections 8, the projections 8 being hot-caulked for fastening to the printed circuit board 3. As an alternative, analogously to FIG. 1, locking catches can be molded onto the light housing 5 in order to lock the printed circuit board 3 to the plastic injection-molded part 6. The printed circuit board 3 has a plug 9 for connecting the LED 2 to a power supply.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications can be made in the embodiment chosen for illustration without departing from the spirit and scope of the invention as defined by the claims.

What is claimed is:

1. An LED light (1) comprising:
at least one LED (2);
a lens (4) for the light that is emitted by the at least one LED (2); and
an opaque light housing (5) which encloses the lens (4),
characterized in that the lens (4) has a transmissive design, and the opaque light housing (5) and the transmissive lens (4) are jointly formed by a two-component plastic injection-molded part (6).

2. The LED light according to claim 1, characterized in that the transmissive lens (4) is designed as a collimator lens or an optical lens.

3. The LED light according to claim 2, characterized in that the transmissive lens (4) is designed as a Fresnel lens.

4. The LED light according to claim 2, characterized in that the exterior of the transmissive lens (4) is smooth.

5. The LED light according to claim 2, characterized in that the exterior of the transmissive lens (4) is provided with structures (7) for additional beam shaping.

6. The LED light according to claim 2, characterized in that the two-component plastic injection-molded part (6) is locked to a printed circuit board (3) having the at least one LED (2).

7. The LED light according to claim 2, characterized in that the two-component plastic injection-molded part (6) is hot-caulked to a printed circuit board (3) having the at least one LED (2).

8. The LED light according to claim 2, characterized in that the two-component plastic injection-molded part (6) is exactly positioned with respect to the at least one LED (2) via projections (8) which engage precisely with holes in a printed circuit board (3) having the at least one LED (2).

9. The LED light according to claim 8, characterized in that the projections (8) are hot-caulked for fastening to the printed circuit board (3).

10. The LED light according to claim 1, characterized in that the exterior of the transmissive lens (4) is smooth.

11. The LED light according to claim 10, characterized in that the two-component plastic injection-molded part (6) is locked to a printed circuit board (3) having the at least one LED (2).

12. The LED light according to claim 10, characterized in that the two-component plastic injection-molded part (6) is hot-caulked to a printed circuit board (3) having the at least one LED (2).

13. The LED light according to claim 10, characterized in that the two-component plastic injection-molded part (6) is exactly positioned with respect to the at least one LED (2) via projections (8) which engage precisely with holes in a printed circuit board (3) having the at least one LED (2).

14. The LED light according to claim 13, characterized in that the projections (8) are hot-caulked for fastening to the printed circuit board (3).

15. The LED light according to claim 1, characterized in that the exterior of the transmissive lens (4) is provided with structures (7) for additional beam shaping.

16. The LED light according to claim 15, characterized in that the two-component plastic injection-molded part (6) is locked to a printed circuit board (3) having the at least one LED (2).

17. The LED light according to claim 15, characterized in that the two-component plastic injection-molded part (6) is hot-caulked to a printed circuit board (3) having the at least one LED (2).

18. The LED light according to claim 15, characterized in that the two-component plastic injection-molded part (6) is exactly positioned with respect to the at least one LED (2) via projections (8) which engage precisely with holes in a printed circuit board (3) having the at least one LED (2).

19. The LED light according to claim 18, characterized in that the projections (8) are hot-caulked for fastening to the printed circuit board (3).

20. The LED light according to claim 1, characterized in that the two-component plastic injection-molded part (6) is locked to a printed circuit board (3) having the at least one LED (2).

21. The LED light according to claim 20, characterized in that the two-component plastic injection-molded part (6) is exactly positioned with respect to the at least one LED (2) via projections (8) which engage precisely with holes in a printed circuit board (3) having the at least one LED (2).

22. The LED light according to claim 21, characterized in that the projections (8) are hot-caulked for fastening to the printed circuit board (3).

23. The LED light according to claim 1, characterized in that the two-component plastic injection-molded part (6) is hot-caulked to a printed circuit board (3) having the at least one LED (2).

24. The LED light according to claim 23, characterized in that the two-component plastic injection-molded part (6) is exactly positioned with respect to the at least one LED (2) via projections (8) which engage precisely with holes in a printed circuit board (3) having the at least one LED (2).

25. The LED light according to claim 24, characterized in that the projections (8) are hot-caulked for fastening to the printed circuit board (3).

26. The LED light according to claim 1, characterized in that the two-component plastic injection-molded part (6) is exactly positioned with respect to the at least one LED (2) via projections (8) which engage precisely with holes in a printed circuit board (3) having the at least one LED (2).

27. The LED light according to claim 26, characterized in that the projections (8) are hot-caulked for fastening to the printed circuit board (3).

28. The LED light according to claim 1, characterized in that the LED light (1) is a refrigerator light.
